(19) United States
(12) Patent Application Publication
(10) Pub. No.: US 2005/0019733 A1
(43) Pub. Date: Jan. 27, 2005

(54) Method of serving beverages

(76) Inventor: David Martin, Vancouver, WA (US)

Correspondence Address: K.M. RYLANDER TRIAL & PATENT ATTORNEY AT LAW PC, Suite 206, 1014 Franklin Street, Vancouver, WA, 98660, US

(21) Appl. No.: 10/625,757

(22) Filed: Jul. 22, 2003

(51) Int. Cl. G06F 17/30; A63F 9/18; A63F 9/00; A63F 3/00; A63F 1/00; G09B 19/00; G06F 17/00; G06F 7/00

(52) U.S. Cl. 434/106; 707/104.1; 273/161

(57) ABSTRACT

A method of serving beverages to a customer in a container having the customer's daily horoscope inscribed thereon includes determining the current date, determining a customer's astrological sign, gathering astrological information specific to the current date and the customer's astrological sign, printing a label inscribed with the current date, the customer's astrological sign, and the gathered astrological information, attaching said label to the outside of a beverage container, and serving said beverage container to the customer, wherein said container contains the customer's selected beverage of choice.

### FIELD OF THE INVENTION

The present invention relates to beverage service. More particularly, the present invention relates to a method of serving beverages while providing printed astrological information specific to the customer on the beverage container.

### BACKGROUND

Contemporary cafés, coffee shops and delis often encourage customers to pass the time and stay awhile by providing a reading-friendly atmosphere. The customer is free to sit and enjoy a cup of coffee while perusing the local newspaper. Furthermore, shop vendors and manufacturers of containers for consumables provide light reading material on the container itself, e.g., a coffee cup having a printed poem or a disposable beverage container with printed advertising and graphics. A more romantic atmosphere is associated with providing a customer-specific message, such as a daily horoscope or an astrological based fortune, on the container in which the beverage is to be consumed.

The following represents a list of known related art:

| Reference: | Issued to: | Date of Issue: |
|---|---|---|
| 5,558,227 | Hakamada | Sept. 24, 1996 |
| Des. 401,808 | Grivsky | Dec. 1, 1998 |

The teachings of each of the above-listed citations (which does not itself incorporate essential material by reference) are herein incorporated by reference. None of the above inventions and patents, taken either singularly or in combination, is seen to describe the instant invention as claimed.

Hakamada describes an automatic vending machine having a constellation designating function for dispensing beverages containing printed astrological information on the container. The consumer inserts a coin or coins into the vending machine. Next, selecting a desired flavor of beverage or type of beverage, the consumer pushes the proper beverage selection button. Then, the consumer selects his or her respective astrological sign by pushing the appropriate constellation selection button. The vending machine dispenses a beverage container having astrological information printed thereon.

### SUMMARY AND ADVANTAGES

A method of serving beverages to a customer in a container having the customer's daily horoscope inscribed thereon includes determining the current date, determining a customer's astrological sign, gathering astrological information specific to the current date and the customer's astrological sign, printing a label inscribed with the current date, the customer's astrological sign, and the gathered astrological information, attaching said label to the outside of a beverage container, and serving said beverage container to the customer, wherein said container contains the customer's selected beverage of choice.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 shows a flow chart for an embodiment of the present invention.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

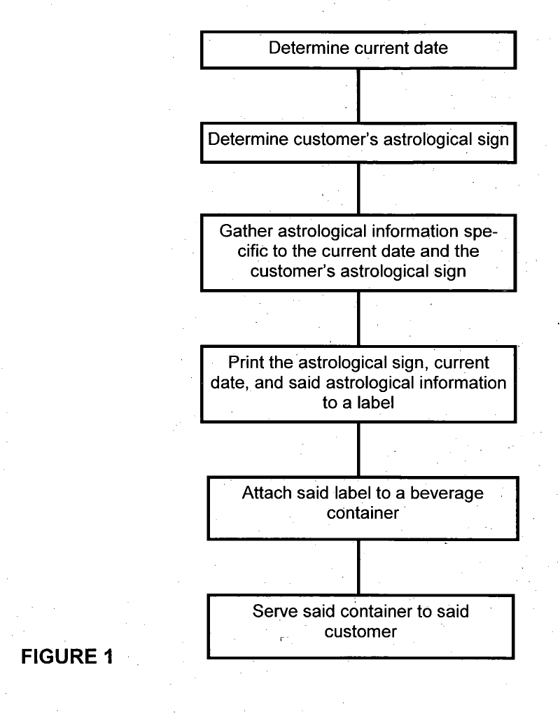

As shown in FIG. 1, a method of serving beverages 10 is provided. The method 10 comprises the steps of determining the current date 20, determining a customer's astrological sign 30, gathering astrological information specific to the current date and the customer's astrological sign 40, printing a label 50 having the current date, the customer's astrological sign, and the gathered astrological information, attaching the label on the outside of a beverage container 60, and serving the container to the customer 70.

The current date 20 is determined by looking at a calendar, a newspaper, or any other known source for determining the current date. In order to determine the customer's astrological sign 30, the customer is asked to provide his or her date of birth and, if known, his or her astrological sign while ordering a beverage. If the customer's sign is not known, the date of birth information provided is corresponded to an astrological calendar such as that shown below to determine the appropriate astrological sign.

| | | |
|---|---|---|
| [symbol] | [symbol] | [symbol] |
| Aries | Leo | Sagittarius |
| March 20-April 19 | July 22-Aug. 22 | Nov. 22-Dec. 21 |
| [symbol] | [symbol] | [symbol] |
| Taurus | Virgo | Capricorn |
| April 20-May 19 | Aug 23-Sept. 21 | Dec. 22-Jan. 19 |
| [symbol] | [symbol] | [symbol] |
| Gemini | Libra | Aquarius |
| May 20-June 20 | Sept. 22-Oct. 22 | Jan. 20-Feb. 17 |
| [symbol] | [symbol] | [symbol] |
| Cancer | Scorpio | Pisces |
| June 21-July 21 | Oct. 23-Nov. 21 | Feb. 18-Mar. 19 |

Once the current date and the astrological sign are determined 20, 30, astrological information specific to the customer's astrological sign and the current date is gathered 40 from any known source. Those skilled in the art will known that known sources include the internet and printed newspapers and periodicals. A database of astrological information by day and by sign can be provided, and the database accessed each time a new customer sign is determined. The daily astrological information includes daily horoscopes and astrological fortunes.

For each customer, a label is printed out 50 that is attachable to the customer's beverage container. The label includes the current date, the astrological sign, and astrological information gathered for that astrological sign for the actual date.

The label is attached to the customer's beverage container 60. The label is attached by known means such as glue, adhesive tape, and other bonding materials suitable for securing printed paper to a beverage container. Last, the beverage and the horoscope inscribed beverage container are served to the customer 70 for consumption and enjoyment.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

1. A method of serving beverages to a customer, comprising:
determining the current date
determining a customer's astrological sign;
gathering astrological information specific to the current date and the customer's astrological sign;
printing a label inscribed with the current date, the customer's astrological sign, and the gathered astrological information;
attaching said label to the outside of a beverage container; and
serving said beverage container to the customer, wherein said container contains the customer's selected beverage of choice.

2. The method of claim 1, wherein the step of gathering astrological information is performed through the use of the internet by searching for the daily horoscope for the customer's astrological sign for the current date.

3. The method of claim 1, wherein the step of gathering astrological information is performed by creating a database of astrological fortunes by day and by astrological sign, wherein said database is accessed for each new customer.

4. The method of claim 1, 2, or 3, wherein the step of printing a label is performed by creating the label on a computer and printing the label to a printer attached to said computer.
